(19) United States
(12) Patent Application Publication
(10) Pub. No.: US 2024/0171959 A1
(43) Pub. Date: May 23, 2024

(54) RESTRICTED RELAY SELECTION PROCEDURE BASED ON COMMUNICATION LINK QUALITY THRESHOLDS

(71) Applicants: Henry CHANG, San Diego, CA (US); Masato FUJISHIRO, San Diego, CA (US); Kyocera Corporation, Kyoto (JP)

(72) Inventors: Henry CHANG, San Diego, CA (US); Masato FUJISHIRO, Yokohama (JP)

(21) Appl. No.: 18/284,149

(22) PCT Filed: Mar. 24, 2022
(86) PCT No.: PCT/US2022/021684

§ 371 Date: Sep. 26, 2023

Related U.S. Application Data
(60) Provisional application No. 63/169,592, filed on Apr. 1, 2021.

(51) Int. Cl. H04W 8/00; H04B 17/318; H04W 48/02; H04W 48/20; H04W 76/20

(52) U.S. Cl. CPC H04W 8/005; H04B 17/328; H04W 48/02; H04W 48/20; H04W 76/20

(57) ABSTRACT

A source user equipment (UE) device is restricted to same-cell relay UE device reselection if the communication link quality to the same-cell relay device is above a threshold and network access is available through a same-cell relay UE device. In some situations, relay selection is based multiple thresholds related to a communication link quality of the link to the serving base station of the source UE device.

### CLAIM OF PRIORITY

The present application claims the benefit of priority to Provisional Application No. 63/169,592 entitled “Discovery Resource for Relaying”, docket number TPRO 00359 US, filed Apr. 1, 2021, assigned to the assignee hereof and hereby expressly incorporated by reference in its entirety.

### FIELD

This invention generally relates to wireless communications and more particularly to resource management of wireless communication links using relay devices.

### BACKGROUND

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D). In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying and the relay UE device establishes a communication path between the remote UE and a base station (gNB) or cell. In some situations, for example, the UE device may be out of the service area of the base station and the relay UE device provides a communication link routed from such an out-of-coverage (OoC) UE device through a relay UE device to the base station. Where the destination device another UE device (target UE device), the relaying functionality is typically referred to as UE-to-UE (U2U) relaying.

### SUMMARY

A remote user equipment (UE) device is restricted to same-cell relay UE device reselection if the communication link quality to the same-cell relay device is above a threshold and network access is available through a same-cell relay UE device. Where the communication link quality to the same-cell relay device is below the threshold, the source UE device performs unrestricted relay reselection that includes evaluating relay UE devices within coverage of one or more cells other than the serving cell of the UE device. The UE device served by a first cell receives a coverage indicator from a same-cell relay UE device served by the first cell where the coverage indicator at least indicates that the same-cell relay UE device is in coverage of the first cell. The source UE device determines a sidelink Reference Signal Received Power (SL-RSRP) level based on a relay sidelink reference signal received from the same-cell relay UE device. If the SL-RSRP level is above a threshold, the source UE device attempts to establish relay communication through the same-cell relay UE device and refrains from performing an unrestricted relay selection procedure that includes evaluating other relay UE devices in coverage of cells other than the first cell. Where an attempt to establish relay communication through the same cell relay UE device fails, the source UE device no longer refrains from performing the unrestricted relay selection procedure and evaluates a relay UE device in coverage of a second cell.

### BRIEF DESCRIPTION OF THE DRAWINGS

FIG. 1 is a block diagram of a communication system for an example where a source user equipment (UE) device performs a restricted relay (re)selection (selection/reselection) procedure based on a quality of a communication link to a same-cell relay UE device

FIG. 2 is a block diagram of the system for an example where management of relay communication is based on multiple link quality thresholds of the communication link between a source UE device and the serving base station.

FIG. 3 is a block diagram of an example of a relay (re)selection configuration information transmission.

FIG. 4 is a block diagram of an example of a base station suitable for use as both the base stations and any base station serving any of the UE devices.

FIG. 5 is a block diagram of an example of a UE device suitable for use as each of the UE devices.

FIG. 6 is a flow chart of an example of a method of performing relay (re)selection based on a relay cell restriction threshold

FIG. 7 is a flow chart of an example of a method of performing relay (re)selection based on multiple serving cell restriction thresholds.

FIG. 8 is a flow chart of an example of a method of performing relay (re)selection based on multiple serving cell restriction thresholds and a relay cell restriction threshold.

### DETAILED DESCRIPTION

As discussed above, a relay UE device provides connectivity between a source UE device and a destination which can be another UE device (destination UE device) or a network. Where the destination is the network, the relay provides connectivity to a cell provided by a base station (gNB) of the network. The relayed connection between a source UE device and destination UE device is sometimes referred to as a UE to UE (U2U) relay connection. The relayed connection between a source UE device and a base station (gNB) is sometimes referred to as a UE to network (U2N) relay connection. In conventional systems where the relay connects to a base station (gNB), the relay UE device is required to meet certain criteria to function as a relay. For example, the relay UE device must be in coverage and have a cellular (Uu) communication link to the base station of sufficient quality in order to be available for relaying functions. For U2N relaying, therefore all candidate relay devices are assumed to be within coverage of the base station (gNB).

With U2U relaying, typically there is no such restriction and the relay UE device may be in coverage or OoC of the cell. The working principle of the two relaying mechanisms are different. Currently, in order for a source UE device and the relay UE device to discover each other as part of the relay selection and reselection procedure, Model A or Model B discovery procedure is used. With Model A discovery, either the remote UE or the relay UE may announce their presence with “I am here” and no response is expected. With Model B discovery, a request is made by announcing “Are you there?” The receiving device may respond to the request of its presence.

Conventional systems support the following two scenarios for Layer 2 (L2) U2N relay procedures: 1) the relay UE device and source UE device are in the same cell before remote connection via the relay UE device, and 2) before remote connection via a relay UE device, the relay UE device and the source UE device are in different cells. Regarding discovery in conventional systems, a source UE device in Radio Resource Control (RRC) states of RRC_CONNECTED, RRC_IDLE and RRC_INACTIVE is allowed to transmit discovery messages if the measured signal strength of the serving cell is lower than a configured threshold. In conventional systems, therefore, the source UE device is able to perform relay selection that includes evaluating relay UE device or other cells when the measured signal strength of its serving cell is lower than a configured threshold.

For the examples herein, however, the source UE device is restricted from performing relay selection that includes evaluating relay UE devices in coverage of other cells when a measured signal strength of a same-cell relay UE device is above a threshold. The source UE device can perform an unrestricted relay selection procedure if a relay connection cannot be established through the same-cell rely UE device. In addition, some examples also restrict the source UE device transmitting discovery signals to select a different-cell relay UE device in coverage of a cell other than the serving cell of the source UE device based on the measured signal level of the serving cell. In addition to the conventional threshold where the source UE device is restricted from selecting any relay UE device if the serving cell measured signal level is above a threshold, the source UE device is restricted from selecting a different-cell relay UE device in coverage of a cell other the serving cell when the serving cell measured signal level is above a second threshold. The second threshold is lower than the conventional threshold (first threshold).

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17).

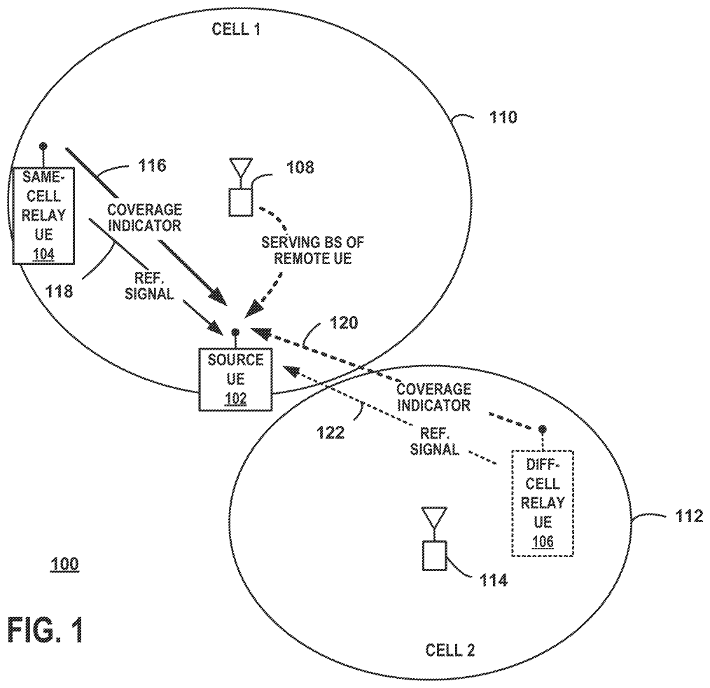

FIG. 1 is a block diagram of communication system 100 for an example where a source UE device 102 performs a restricted relay selection/reselection procedure based on a quality of a communication link to a same-cell relay UE device 104. In examples discussed herein, the source UE device 102 only considers a different-cell relay UE device 106 during the relay selection/reselection procedure if the sidelink Reference Signal Received Power (SL-RSRP) of the link to the same-cell relay UE device 104 is below a cell restriction threshold or the communication link through the same-cell relay is unsuccessful. For the example of FIG. 1, the serving base station of the source UE device 102 is a first base station 108, such as a gNB, providing a first cell 110 and the source UE device 102 is located within coverage of the first cell 110. The different-cell relay UE device 106 is within coverage of a second cell 112 provided by a second base station 114. Although the two cells may be provided by the same gNB in some situations, the second cell 112 is provided by the second base station 114, such as another gNB, in the example.

For the example, the source UE device 102 is within coverage of the first cell 110 while being served by the first base station 108. The source UE device 102 determines that it is within coverage of the first cell 112. The source UE device 102 receives a coverage indicator 116, from the same-cell relay UE device 104, indicating that the same-cell relay UE device 104 is in-coverage of the first cell 110. The source UE device 102 determines that relay UE device 104 is in coverage of the same cell (first cell 110) providing service to the source UE device 102. For the examples herein, the source UE device 102 is determined to be in-coverage of a cell when it is camped on the cell where the source UE device 102 is in the RRC IDLE state or the RRC INACTIVE state with the cell, without connecting indirectly via a relay UE device. The source UE device 102, therefore, determines that it is in coverage of the first cell 112 if it is camped on the first cell 112. The source UE device evaluates the coverage indicator 116 and determines that the same-cell relay UE device 104 is within coverage of the same cell (first cell 110) that is providing service to the source UE device 102.

The source UE device measures a reference signal 118 transmitted by the same-cell relay UE device and determines whether the source UE device may execute and unrestricted relay selection procedure based on measured level of the reference signal 118. For the example, the measured SL-RSRP level is compared to the relay cell restriction threshold and, if the measured SL-RSRP level is below the relay cell restriction threshold, the source UE device 102 determines that an unrestricted relay selection procedure can be performed. Otherwise, the UE device determines that the relay selection procedure is restricted to same-cell UE devices. The unrestricted relay selection procedure includes evaluating relay UE devices (different-cell relay UE devices) in coverage of cells other than the cell (first cell 110) providing service to the source UE device 102, such as the different-cell relay UE device 106.

The source UE device 102 receives a coverage indicator 120 from the different-cell relay UE device 106 that indicates the different-cell relay UE device 106 is in coverage of the second cell 112. When the relay selection/reselection is unrestricted, the source UE device 102 receives and measures a SL reference signal 122 transmitted by the different-cell relay UE device 106. The source UE device 102 performs relay (re)selection based on SL-RSRP of the SL reference signal 122. In the interest of brevity and clarity, the example of FIG. 1 includes a single same-cell relay UE device and single different-cell relay UE device. The relay selection/reselection procedure, however, may include evaluating multiple relay UE devices in coverage of different cells. The different-cell relay UE device 106, the coverage indicator 120 and the reference signal 122 are illustrated with dashed lines in FIG. 1 in order to indicate that the remote UE may not evaluate one or more of the signals 120, 122 transmitted from the different-cell really UE device 106 in some situations. For example, the source UE device 102 may not measure the reference signal 122 where the SL-RSRP level of the same-cell relay UE device 104 is above the cell restriction threshold and the source UE device is able to connect to the network through the same-cell relay UE device 104. When performing the unrestricted relay (re)selection procedure, therefore, the source UE device 102 may evaluate different-cell relay UE devices as well as same-cell relay UE devices and may receive numerous reference signals transmitted from both same-cell UE devices and different-cell UE devices.

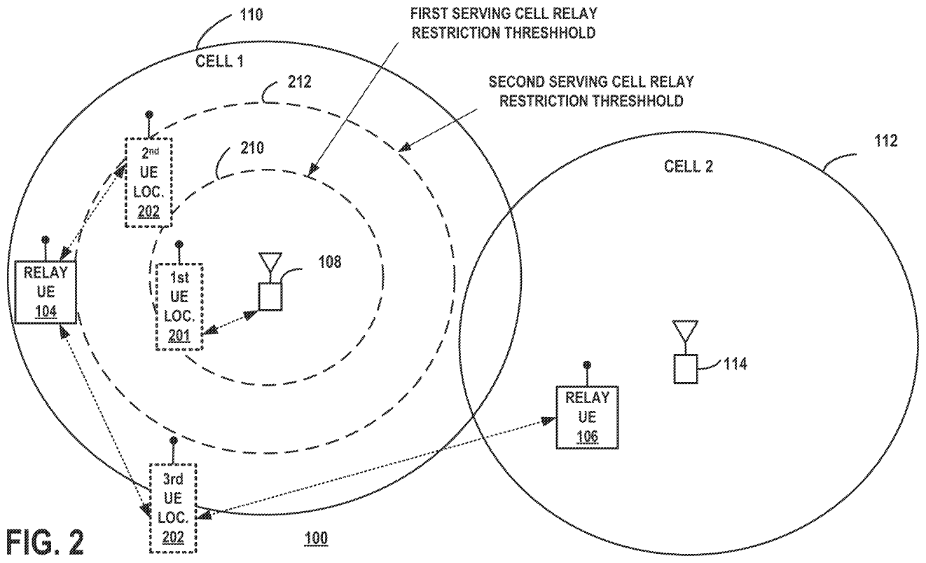

FIG. 2 is a block diagram of the system 100 for an example where management of relay communication is based on multiple link quality thresholds of the communication link between a source UE device 102 and its serving base station (first base station 108). For the example, three UE device locations 201, 202, 203 of the source UE device 102 are considered. The locations 201, 202, 203 are represented with UE device blocks having dashed lines in FIG. 2 to illustrate that the source UE device 102 may be located at one of the locations. FIG. 2 includes two dashed-line circles 210, 212 around the base station 108 where each circle represents a link quality of the communication link to the base station 108. For the example, the link quality is measured by the RSRP level of a signal received from the base station 108 where the measured signal may be reference signal. Each circle, therefore, represents a RSRP level threshold such that a UE device located within a circle measures an RSRP level of the base station 108 above an RSRP level associated with the circle. A first relay first relay restriction threshold 210 is represented by the first circle 210 and a second relay restriction threshold 212 is represented by the second circle 212. In the example, a UE device in the first location 201 measures an RSRP level of a signal (not shown) transmitted by the base station 108 to be above the first relay restriction threshold 210. A UE device in the second location 202 measures an RSRP level of a signal transmitted by the base station 108 to be below the first relay restriction threshold 210 and above the second relay restriction threshold 212. A UE device in the third UE device 203 measures an RSRP level of a signal transmitted by the base station 108 to be below the second relay restriction threshold 212. In the interest of clarity, the dashed lines representing the thresholds 210, 212 are shown as circles although the actual shape of such a demarcation may be less uniform as a result of communication path variations within the region.

For the example of FIG. 2, the relay selection/reselection performed by the source UE device is at least partially based on the measured RSRP level of a signal transmitted by the base station 108. The source UE device 102 measures an RSRP level greater than the first relay restriction threshold 210 when in the first location 201. In response to determining that the RSRP level is higher than the first relay restriction threshold 210, the source UE device 102 refrains from evaluating relay UE devices for connection to the network. The source UE device 102 does not transmit discovery signals for reception by relay UE devices. For the case when the source UE device 102 receives a discovery signal from the relay UE 104, the source UE device 102 will also refrain from transmitting the Direct Communication Request message (a PC5-S message used to establish PC5 connection with the relay UE). The first relay restriction threshold 210 can be configured by the base station and establishes when the source UE device 102 is authorized to transmit discovery signals. Where the RSRP level is below the first relay restriction threshold 210, the source UE device 102 may transmit discovery signals in order to identify and evaluate relay UE devices for relay (re)selection. Such a technique is in accordance with some conventional systems where a UE device is managed to directly connect to the cell (base station) when the UE device is close to the center of the cell and experiencing a relatively high-quality communication link to the cell. For the examples herein, however, the second relay restriction threshold 212 may be configured by the base station 108 to further manage the relay (re)selection.

When the UE device measures an RSRP level that is above the second threshold 212 but below the first threshold 210, such as when the UE device 102 is in the second location 202, the source UE device 102 is authorized to consider same-cell relay UE devices. Accordingly, the UE device 102 may transmit SL discovery signals for relay (re)selection but only evaluates same-cell relay UE devices. In some configurations and situations, the source UE device may consider different-cell relay UE devices but prioritizes same-cell relay UE devices. For example, if no same-cell relay UE device can be identified that is capable of providing communication link to the network at the required minimum quality level, the source UE device 102 may select a different-cell relay UE device or communicate directly with the base station 108.

When the measured RSRP level to the base station is below the second relay restriction threshold 212, the source UE device 102 is authorized to select different-cell relay UE devices, such as the different-cell relay UE device 106 in the example. Therefore, the multiple thresholds allow management of resource and the prioritization of same-cell relay UE devices and different-cell relay UE devices.

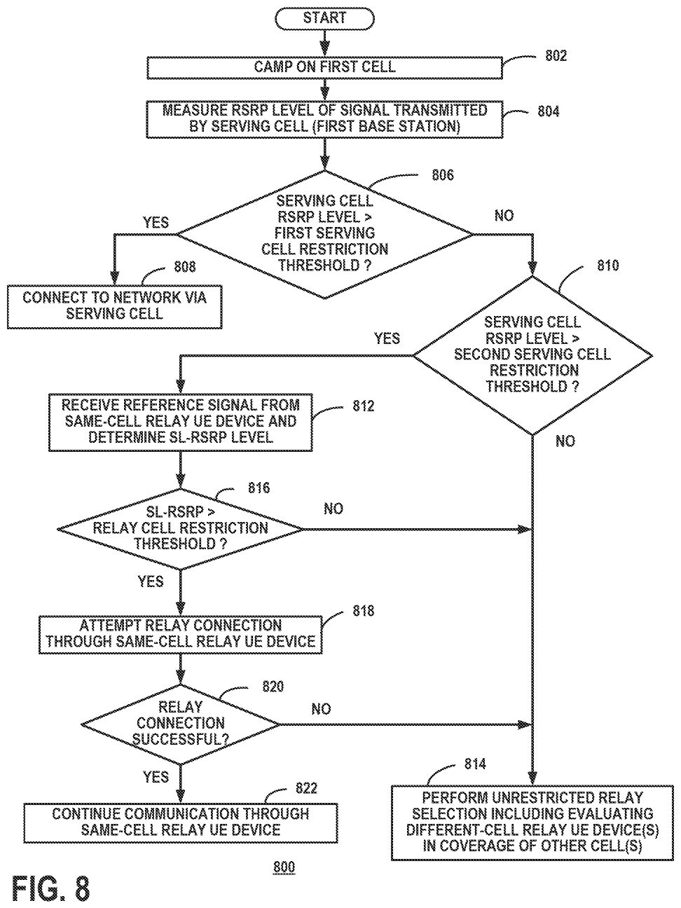

In some situations, the techniques discussed with reference to FIG. 1 are combined with the techniques discussed with reference to FIG. 2. In other words, the relay (re)selection procedure may be based on the serving cell RSRP level of the serving cell 110 relative to the serving cell threshold and the SL-RSRP level of the same-cell relay UE devices relative to the relay cell restriction threshold. An example of such a technique is discussed with reference to FIG. 8.

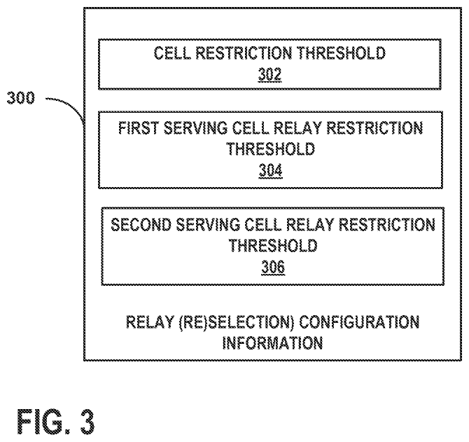

FIG. 3 is a block diagram of an example of a relay (re)selection configuration information transmission 300. For the example, the relay (re)selection configuration information transmission 300 is provided to the source UE device 102 in a System Information Block (SIB). The relay (re)selection configuration information transmission 300, however, may be provided to the source UE device using other techniques in some situations. For the example of FIG. 3, the relay (re)selection configuration information 300 includes a relay cell restriction threshold 302, a first serving cell restriction threshold and a second serving cell restriction threshold. In some situations, one or more of the thresholds may be omitted. Also, the thresholds may be transmitted in separates transmissions or may be otherwise provided at different times.

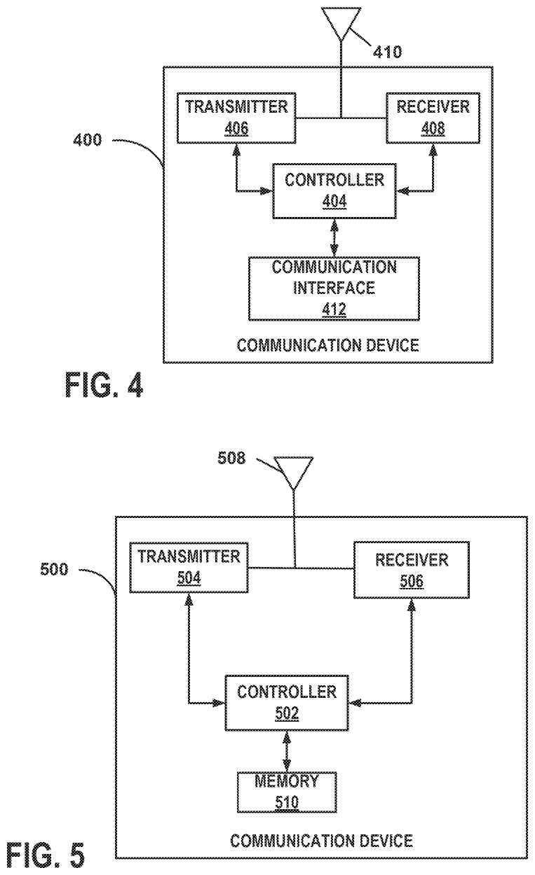

FIG. 4 is a block diagram of an example of a base station 400 suitable for use as both the base stations 108, 114 and any base station providing a cell or otherwise serving any of the UE devices. The base station 400 includes a controller 404, transmitter 406, and receiver 408, as well as other electronics, hardware, and code. The base station 400 is any fixed, mobile, or portable equipment that performs the functions described herein. The various functions and operations of the blocks described with reference to the base stations 108, 114, 400 may be implemented in any number of devices, circuits, or elements. Two or more of the functional blocks may be integrated in a single device, and the functions described as performed in any single device may be implemented over several devices. The base station 400 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 400 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 400 may be a portable device that is not fixed to any particular location.

The controller 404 includes any combination of hardware, software, and/or firmware for executing the functions described herein as well as facilitating the overall functionality of the base station 400. An example of a suitable controller 404 includes code running on a microprocessor or processor arrangement connected to memory. The transmitter 406 includes electronics configured to transmit wireless signals. In some situations, the transmitter 406 may include multiple transmitters. The receiver 408 includes electronics configured to receive wireless signals. In some situations, the receiver 408 may include multiple receivers. The receiver 408 and transmitter 406 receive and transmit signals, respectively, through an antenna 410. The antenna 410 may include separate transmit and receive antennas. In some circumstances, the antenna 410 may include multiple transmit and receive antennas.

The transmitter 406 and receiver 408 in the example of FIG. 4 perform radio frequency (RF) processing including modulation and demodulation. The receiver 408, therefore, may include components such as low noise amplifiers (LNAs) and filters. The transmitter 406 may include filters and amplifiers. Other components may include isolators, matching circuits, and other RF components. These components in combination or cooperation with other components perform the base station functions. The required components may depend on the particular functionality required by the base station.

The transmitter 406 includes a modulator (not shown), and the receiver 408 includes a demodulator (not shown). The modulator modulates the signals to be transmitted as part of the downlink signals and can apply any one of a plurality of modulation orders. The demodulator demodulates any uplink signals received at the base station 400 in accordance with one of a plurality of modulation orders.

The base station 400 includes a communication interface 412 for transmitting and receiving messages with other base stations. The communication interface 412 may be connected to a backhaul or network enabling communication with other base stations. In some situations, the link between base stations may include at least some wireless portions. The communication interface 412, therefore, may include wireless communication functionality and may utilize some of the components of the transmitter 406 and/or receiver 408.

FIG. 5 is a block diagram of an example of a UE device 500 suitable for use as each of the UE devices 102, 104, 106. In some examples, the UE device 500 is any wireless communication device such as a mobile phone, a transceiver modem, a personal digital assistant (PDA), a tablet, or a smartphone. In other examples, the UE device 500 is a machine type communication (MTC) communication device or Internet-of-Things (IOT) device. The UE device 500, therefore is any fixed, mobile, or portable equipment that performs the functions described herein. The various functions and operations of the blocks described with reference to UE device 500 may be implemented in any number of devices, circuits, or elements. Two or more of the functional blocks may be integrated in a single device, and the functions described as performed in any single device may be implemented over several devices.

The UE device 500 includes at least a controller 502, a transmitter 504 and a receiver 506. The controller 502 includes any combination of hardware, software, and/or firmware for executing the functions described herein as well as facilitating the overall functionality of a communication device. An example of a suitable controller 502 includes code running on a microprocessor or processor arrangement connected to memory. The transmitter 504 includes electronics configured to transmit wireless signals. In some situations, the transmitter 504 may include multiple transmitters. The receiver 506 includes electronics configured to receive wireless signals. In some situations, the receiver 506 may include multiple receivers. The receiver 504 and transmitter 506 receive and transmit signals, respectively, through antenna 508. The antenna 508 may include separate transmit and receive antennas. In some circumstances, the antenna 508 may include multiple transmit and receive antennas.

The transmitter 504 and receiver 506 in the example of FIG. 5 perform radio frequency (RF) processing including modulation and demodulation. The receiver 504, therefore, may include components such as low noise amplifiers (LNAs) and filters. The transmitter 506 may include filters and amplifiers. Other components may include isolators, matching circuits, and other RF components. These components in combination or cooperation with other components perform the communication device functions. The required components may depend on the particular functionality required by the communication device.

The transmitter 506 includes a modulator (not shown), and the receiver 504 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

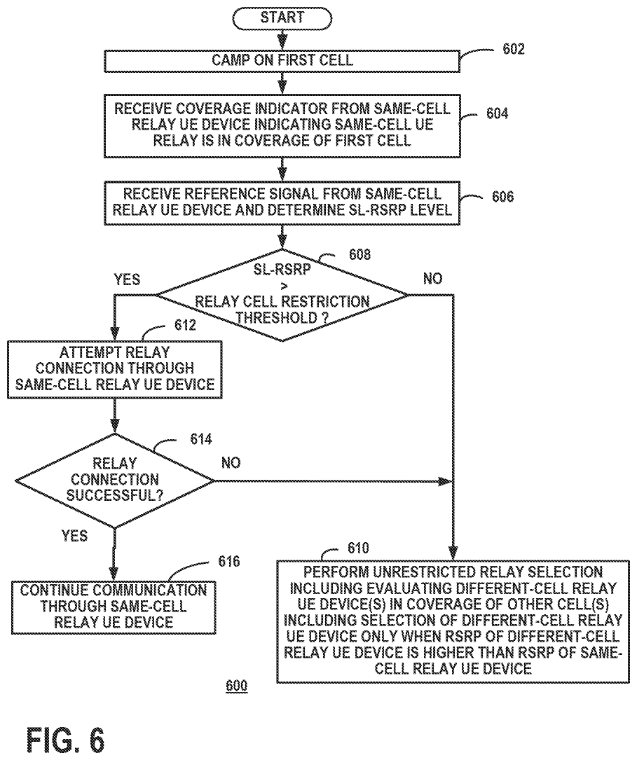

FIG. 6 is a flow chart of an example of a method 600 of performing relay (re)selection based on a relay cell restriction threshold. The method, therefore, may be performed by a UE device such as the source UE device 102 discussed above.

At step 602, the source UE device 102 is camped on the first cell 110. The source UE device 103, therefore, is within coverage of the first cell 110 while being served by the first base station 108. For the examples herein, the source UE device 102 is determined to be in-coverage of a cell when it is camped on the cell where the source UE device 102 is in the RRC IDLE state or the RRC INACTIVE state with the cell, without connecting indirectly via a relay UE device.

At step 604, the source UE device 102 receives a coverage indicator 116, from the same-cell relay UE device 104, indicating that the same-cell relay UE device 104 is in-coverage of the first cell 110. The same-cell relay UE device 104 may send the coverage indicator 116 in a PC5 broadcast message, such as a sidelink discovery signal, or the coverage indicator 104 may be part of the MAC header, part of the upper layer message, or may be a field within the physical sidelink control channel (PSCCH). The coverage indicator 116 indicates that the same-cell relay UE device 104 is within coverage of the first cell 110 and may provide additional information in some situations. In the example, therefore, the coverage indicator 116 at least identifies the first cell 110 with a unique identifier, such as cell ID. The source UE device 102 determines that relay UE device 104 is in coverage of the same cell (first cell 110) providing service to the source UE device 102. In some situations, transmission of the coverage indicator can be omitted or may be part of other transmissions. For example, a U2N relay UE candidate may transmit discovery that includes the cell ID of the cell on which the U2N relay UE candidate is camped. Although a U2N relay UE device cannot send discovery unless the device is in coverage, a U2U relay may transmit discovery even when out of coverage. At step 606, the source UE device receives a reference signal from the same cell relay UE device 104 and measures the signal to determine the SL-RSRP level.

At step 608, the source UE device determines whether the measured SL-RSRP is greater than the relay cell restriction threshold. If the measured SL-RSRP is not greater than the relay cell restriction threshold, the method continues at step 610, Otherwise, the method proceeds to step 612.

At step 610, the source UE device 102 performs an unrestricted relay selection procedure where different-cell relay UE devices can be evaluated and considered for relay (re)selection. For example, the different-cell relay UE device 106 can be identified during discovery and determined to be within the second cell 112 based on received coverage indicator. The source UE device 102 evaluates RSRP levels and other criteria in accordance with relay reselection to determine whether to select the different-cell relay UE device 106. For the example, a different-cell relay UE device is selected only when a measured SL-RSRP level of the different-cell relay UE device is greater than a measured SL-RSRP level of a same-cell relay UE device. Therefore, where there is no different-cell relay UE device having a SL-RSRP level greater than the SL-RSRP level of a same-cell relay UE device, communication may continue through the same-cell relay UE device even if the SL-RSRP of the same-cell relay UE device is not greater than the relay cell restriction threshold.

At step 612, the source UE device attempts a relay connection to the network through the same-cell relay UE device 104.

At step 614, it is determined whether the relay connection was successful. Examples of reasons that the relay connection through the relay UE device 104 may not be successful include traffic congestion in the serving cell, access barring, rejection of the establishment request or the establishment cannot be originated. If the relay connection is successful, the method proceeds to step 616 where the communication continues through the same-cell relay UE device 104. Otherwise, the method continues at step 610 where the source UE device 102 performs the unrestricted relay (re)selection.

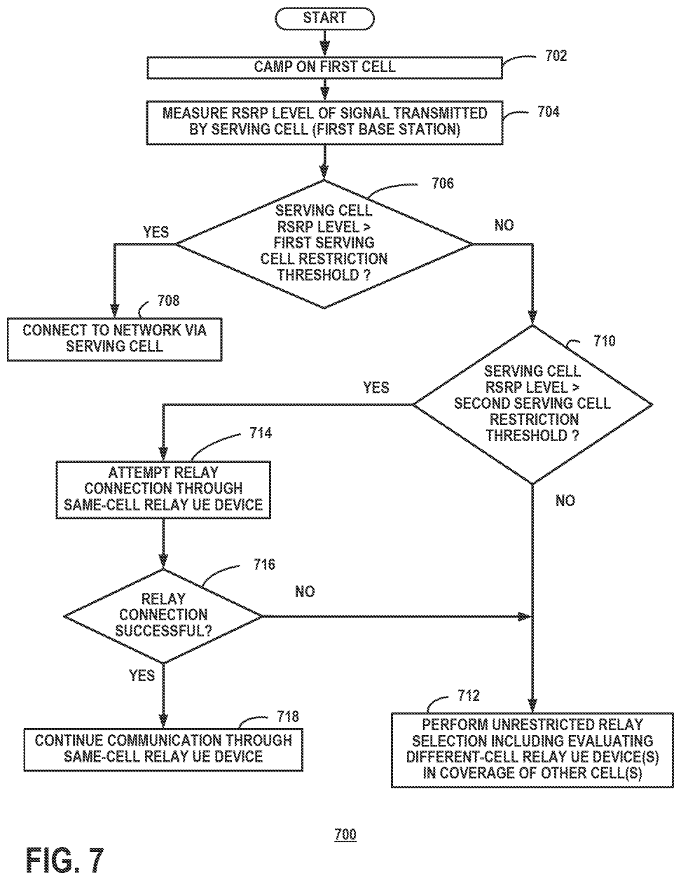

FIG. 7 is a flow chart of an example of a method 700 of performing relay (re)selection based on multiple serving cell restriction thresholds. The method, therefore, may be performed by a UE device such as the source UE device 102 discussed above.

At step 702, the source UE device 102 is camped on the first cell 110. The source UE device 103, therefore, is within coverage of the first cell 110 while being served by the first base station 108. For the examples herein, the source UE device 102 is determined to be in-coverage of a cell when it is camped on the cell where the source UE device 102 is in the RRC IDLE state or the RRC INACTIVE state with the cell, without connecting indirectly via a relay UE device.

At step 704, the RSRP level of the serving cell is measured. For the example, the source UE device 102 receives and measures a reference signal transmitted by the serving cell, such as a reference signal transmitted by the first base station 108 in the first cell 110.

At step 706, the source UE device determines whether the measured serving cell RSRP level is greater than a first serving cell restriction threshold. If the measured RSRP is greater than the first serving cell restriction threshold, the method continues at step 708 where the source UE device connects to the network directly through the first cell 110 provided by the first base station 108. Otherwise, the method proceeds to step 710.

At step 710, the source UE device determines whether the measured serving cell RSRP level is greater than a second serving cell restriction threshold. The second serving cell restriction threshold is less than the first serving cell restriction threshold. If the measured RSRP is not greater than the second serving cell restriction threshold, the method continues at step 712. Otherwise, the method continues at step 714.

At step 712, the source UE device 102 performs an unrestricted relay selection procedure where different-cell relay UE devices can be evaluated and considered for relay (re)selection. For example, the different-cell relay UE device 106 can be identified during discovery and determined to be within the second cell 112 based on received coverage indicator. The source UE device 102 evaluates SL-RSRP levels and other criteria in accordance with relay reselection to determine whether to select the different-cell relay UE device 106. For the example, a different-cell relay UE device is selected only when a measured SL-RSRP level of the different-cell relay UE device is greater than a measured SL-RSRP level of a same-cell relay UE device. Therefore, communication may continue through the same-cell relay UE device even if the SL-RSRP of the same-cell relay UE device is not greater than the relay cell restriction threshold when no different-cell relay UE device has a SL-RSRP level greater than the SL-RSRP level of a same-cell relay UE device.

At step 714, the source UE device attempts a relay connection to the network through the same-cell relay UE device 104.

At step 716, it is determined whether the relay connection was successful. Examples of reasons that the relay connection through the relay UE device 104 may not be successful include traffic congestion in the serving cell, access barring, rejection of the establishment request or the establishment cannot be originated. If the relay connection is successful, the method proceeds to step 718 where the communication continues through the same-cell relay UE device 104. Otherwise, the method continues at step 712 where the source UE device 102 performs the unrestricted relay (re)selection.

FIG. 8 is a flow chart of an example of a method 800 of performing relay (re)selection based on multiple serving cell restriction thresholds and a relay cell restriction threshold. The method, therefore, may be performed by a UE device such as the source UE device 102 discussed above.

At step 802, the source UE device 102 is camped on the first cell 110. The source UE device 103, therefore, is within coverage of the first cell 110 while being served by the first base station 108. For the examples herein, the source UE device 102 is determined to be in-coverage of a cell when it is camped on the cell where the source UE device 102 is in the RRC IDLE state or the RRC INACTIVE state with the cell, without connecting indirectly via a relay UE device.

At step 804, the RSRP level of the serving cell is measured. For the example, the source UE device 102 receives and measures a reference signal transmitted by the serving cell, such as a reference signal transited by the first base station 108 in the first cell 110.

At step 806, the source UE device determines whether the measured serving cell RSRP level is greater than a first serving cell restriction threshold. If the measured RSRP is greater than the first serving cell restriction threshold, the method continues at step 808 where the source UE device connects to the network directly through the first cell 110 provided by the first base station 108. Otherwise, the method proceeds to step 810.

At step 810, the source UE device determines whether the measured serving cell RSRP level is greater than a second serving cell restriction threshold. The second serving cell restriction threshold is less than the first serving cell restriction threshold. If the measured RSRP is not greater than the second serving cell restriction threshold, the method continues at step 812. Otherwise, the method continues at step 814.

At step 812, the source UE device 102 performs an unrestricted relay selection procedure where different-cell relay UE devices can be evaluated and considered for relay (re)selection. For example, the different-cell relay UE device 106 can be identified during discovery and determined to be within the second cell 112 based on received coverage indicator. The source UE device 102 evaluates SL-RSRP levels and other criteria in accordance with relay reselection to determine whether to select the different-cell relay UE device 106. For the example, a different-cell relay UE device is selected only when a measured SL-RSRP level of the different-cell relay UE device is greater than a measured SL-RSRP level of a same-cell relay UE device. Therefore, communication may continue through the same-cell relay UE device even if the SL-RSRP of the same-cell relay UE device is not greater than the relay cell restriction threshold where no different cell rely UE device has a SL-RSRP level greater than the SL-RRP level of a same-cell relay UE device.

At step 814, the source UE device receives a reference signal from the same cell relay UE device 104 and measures the signal to determine the SL-RSRP level.

At step 816, the source UE device determines whether the measured SL-RSRP is greater than the relay cell restriction threshold. If the measured SL-RSRP is not greater than the relay cell restriction threshold, the method continues at step 812. Otherwise, the method proceeds to step 818.

At step 818, the source UE device attempts a relay connection to the network through the same-cell relay UE device 104.

At step 820, it is determined whether the relay connection was successful. Examples of reasons that the relay connection through the relay UE device 104 may not be successful include traffic congestion in the serving cell, access barring, rejection of the establishment request or the establishment cannot be originated. If the relay connection is successful, the method proceeds to step 822 where the communication continues through the same-cell relay UE device 104. Otherwise, the method continues at step 812 where the source UE device 102 performs the unrestricted relay (re)selection.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A source user equipment (UE) device comprising:
a receiver configured to receive:
a discovery signal broadcasting cell identifier from a same-cell relay UE device that is in coverage of a first cell, and
a relay reference signal from the same-cell relay UE device;
a controller configured to
determine a first cell sidelink Reference Signal Received Power (SL-RSRP) level based on the relay reference signal received from the same-cell relay UE device;
in response to a determination that the first cell SL-RSRP level is below a relay cell restriction threshold, perform an unrestricted relay selection procedure that comprises evaluating a different-cell relay UE device for potential use as a relay, the different-cell relay UE device within coverage of a second cell different from the first cell.

2. The source UE device of claim 1, wherein:
the receiver is further configured to receive a serving cell reference signal from a base station providing the serving cell;
the controller is further configured to:
determine a serving cell RSRP level based on the serving cell reference signal,
determine whether the serving cell RSRP level is greater than a first serving cell restriction threshold,
determine whether the serving cell RSRP level is greater than a second serving cell restriction threshold,
in response to a determination that the serving cell RSRP level is greater than the second serving cell restriction threshold, refrain from performing the unrestricted relay selection procedure,
perform a restricted relay selection procedure in response to a determination that the serving cell RSRP level is greater than the second serving cell restriction threshold and is not greater than the first serving cell restriction threshold, the restricted relay selection procedure comprising evaluating only same-cell relay UE devices within coverage of the first cell.

3. The source UE device of claim 2, wherein the controller is further configured to, in response to a determination that the serving cell RSRP level is greater than the first serving cell restriction threshold, connect directly to the first cell without a relay connection and refrain from performing the restricted relay selection and the unrestricted relay selection.

4. The source UE device of claim 1, wherein:
the receiver is further configured to receive another relay reference signal from the different-cell relay UE device; and
the controller is configured to determine a second cell SL-RSRP level based on the another relay reference signal received from the different-cell relay UE device and to select the different-cell relay UE device for a relay connection in response to determination that the second cell SL-RSRP level is greater than the first cell SL-RSRP level.

5. The source UE device of claim 1, wherein the controller is further configured to:
attempt connecting to a network through the same-cell relay UE device;
determining whether a relay connection to the first cell through the same-cell relay UE device was successful;
in response to a determination that the relay connection was not successful, performing the unrestricted relay selection procedure.

6. The source UE device of claim 1, wherein the source UE device operates in accordance with at least one revision of a 3GPP New Radio (NR) V2X communication specification.

7. The source UE device of claim 6, wherein the source UE device is connected to a network through the first cell in a Radio Resource Control (RRC) state where the RRC state is one of a RRC_CONNECTED state, RRC_IDLE state and a RRC_INACTIVE state.

8. The source UE device of claim 1, wherein the unrestricted relay selection procedure comprises evaluating other same-cell relay UE devices for potential use as a relay, the other same-cell relay UE devices within coverage of the first cell.

9. A base station providing a first cell, the base station comprising:
a controller configured to determine a relay cell restriction threshold for a source user equipment (UE) device within coverage of the first cell, the relay cell restriction threshold indicating a minimum first cell sidelink Reference Signal Received Power (SL-RSRP) level that authorizes the source UE device to perform an unrestricted relay selection procedure; and
a transmitter configured to transmit a relay selection configuration information transmission indicating the relay cell restriction threshold to the source UE device,
the unrestricted relay selection procedure comprising evaluating a different-cell relay UE device for potential use as a relay, the different-cell relay UE device within coverage of a second cell different from the first cell,
the first cell SL-RSRP level determined by the source UE device by measuring a signal transmitted by a same-cell relay UE device within coverage of the first cell.

10. The base station of claim 9, wherein:
the controller is further configured to determine a first serving cell restriction threshold and a second serving cell restriction threshold, the relay selection configuration information transmission indicating the first serving cell restriction threshold and the second serving cell restriction threshold to the source UE device,
the second serving cell restriction indicates a minimum serving cell RSRP level that authorizes the source UE device to perform the unrestricted relay selection procedure,
the first serving cell restriction indicates a minimum serving cell RSRP level that authorizes the source UE device to perform a same-cell relay selection procedure comprising evaluating, for relay selection, same-cell UE devices within coverage of the first cell.

11. The base station of claim 9, wherein the base station operates in accordance with at least one revision of a 3GPP New Radio (NR) V2X communication specification.

12. The base station of claim 11, wherein the source UE device is connected to a network through the first cell in a Radio Resource Control (RRC) state where the RRC state is one of a RRC_CONNECTED state, RRC_IDLE state and a RRC_INACTIVE state.
